(19) United States
(12) Patent Application Publication
(10) Pub. No.: US 2004/0070778 A1
(43) Pub. Date: Apr. 15, 2004

(54) Image processing apparatus

(75) Inventor: Toru Matama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/680,261

(22) Filed: Oct. 8, 2003

Related U.S. Application Data
(63) Continuation of application No. 09/276,759, filed on Mar. 26, 1999.

(30) Foreign Application Priority Data
Mar. 27, 1998 (JP) 10-080910

(51) Int. Cl. G06K 15/12; H04N 1/387; G06T 5/00

(52) U.S. Cl. 358/1.9; 382/260; 382/284; 358/1.18; 358/450

(57) ABSTRACT

The image processing apparatus comprises a synthesis unit and a selection unit or an image processing unit or both units. The synthesis unit synthesizes image data of a plurality of images obtained by taking a same scene under different exposure conditions or image data of a plurality of optimal images selected by the selection unit to generate synthesized image data of a composite image. The selection unit selects the plurality of the optimal images for synthesis among the image data of the plurality of images described above. The image processing unit for subjecting the synthesized image data by the synthesis unit to dodging processing. The apparatus can secure a sufficient dynamic range of the image data even when the scene having a high contrast is taken by a digital camera that has a narrow photographing latitude and also output prints reproducing high-quality images.

### CROSS-REFERENCE TO RELATED APPLICATIONS

This is a Continuation of application Ser. No. 09/276,759 filed Mar. 26, 1999, the disclosure of which is incorporated herein by reference.

### BACKGROUND OF THE INVENTION

This invention relates to the field of image processing technology for preferable use with digital photoprinters.

Heretofore, the images recorded on photographic films such as negatives and reversals (which are hereunder referred to simply as “films”) have been commonly printed on light-sensitive materials (photographic paper) by means of direct (analog) exposure in which the film image is projected onto the light-sensitive material to achieve its areal exposure.

A new technology has recently been introduced and this is a printer that relies upon digital exposure. Briefly, the image recorded on a film is read photoelectrically converted to digital signals and subjected to various image processing operations to produce image data for recording purposes; recording light that has been modulated in accordance with the image data is used to scan and expose a light-sensitive material to record a latent image, which is subsequently developed to produce a (finished) print. The printer operating on this principle has been commercialized as a digital photoprinter.

In the digital photoprinter, images can be processed as digital image data so that exposure conditions at the time of printing can be determined. Accordingly, the digital photoprinter can perform effective image processing operations such as correction of washed-out highlights or flat (dull) shadows due to the taking of pictures with back light, an electronic flash or the like, sharpening processing and the like to produce high-quality prints that have been unable to achieve by the conventional direct exposure technique. Moreover, in the digital photoprinter, images can be processed as digital image data, so not only the synthesizing of images and the splitting of a single image into plural images but also the synthesis of characters and the like can be performed by processing the image data and, as a result, prints can be outputted after various editing and/or processing operations have been performed in accordance with specific uses.

Outputting images as prints (photographs) is not the sole capability of the digital photoprinter; the image data can be supplied into a computer or the like and stored in recording media such as a floppy disk; hence, the image data can find various non-photographic uses.

The digital photoprinter can output as prints not only images recorded on films, but also images (image data) recorded by recording devices such as digital cameras, digital video cameras and the like.

Having these features, the digital photoprinter is essentially synthesized of the following units: a scanner (image reading apparatus) that reads the image on a film photoelectrically by reading projected light formed by allowing reading light to be incident on the film; an image processing apparatus that subjects the image captured by the scanner or the image data provided by a digital camera and the like to specified image processing to produce image data for image recording, that is, exposure conditions; a printer (image recording apparatus) that records a latent image on a light-sensitive material by scan exposing of light beams and the like in accordance with the image data supplied from the image processing apparatus; and a processor (developing apparatus) that performs development processing on the exposed light-sensitive material to produce a (finished) print.

When a scene that has a high contrast is photographed optically, all information (images) of the scene are not always recorded depending on dynamic ranges of respective recording media so that, in some cases, sufficient image data can be obtained for reproducing the scene as a print.

Specifically, since the digital camera has a narrow photographing latitude (exposure latitude), it is difficult for an amateur photographer who has no high-level technique to take pictures under the optimal conditions. Accordingly, the scene having a high contrast tends to be an image of extremely low quality with washed-out highlights (maximum density) or dull shadows (minimum density) in many cases.

In order to solve the above problems, methods and apparatus have been proposed to the effect that the same scene is taken by a digital camera with different exposure conditions such as two conditions of a low exposure light quantity and a high exposure light quantity brought about, for example, by changing storage time of CCD sensors to obtain image data without having washed-out highlights or dull shadows on image scenes and then to synthesize the two images (image data) thus obtained into one. These methods and apparatus are disclosed in patent publications such as Japanese Unexamined Patent Publications (hereinafter called as “JPA”) No. 6-141229, No. 7-131704 and No. 7-131718.

According to these publications, it becomes possible to obtain a suitable image data without having washed-out highlights or dull shadows in the high contrast scene while securing a satisfactory dynamic range of the image data even by a digital camera that is of a type which has generally a narrow recording latitude.

However, cost of the digital camera having these methods will increase in cases. Moreover, it is necessary to prepare in advance two optimal images for a synthesizing purpose. Furthermore, the optimal image data are not always obtained when prints are produced by the aforementioned digital photoprinter.

### SUMMARY OF THE INVENTION

An object of the invention is to solve the above mentioned problems in the prior art, and to provide an image processing apparatus for being capable of securing sufficient dynamic range of an image data even when a scene having a high contrast is taken by and recorded with a digital camera having a narrow photographing latitude, capable of selecting optimal images suitable for being synthesized from among a plurality of images of a same scene taken under different exposure conditions, and being capable of obtaining image data to produce a print (photograph) that reproduces a high-quality image.

To achieve the above object, a first aspect of the invention is to provide an image processing apparatus, comprising:

synthesis means for synthesizing image data of a plurality of images obtained by taking a same scene under different exposure conditions to generate synthesized image data of a composite image; and

image processing means for subjecting the synthesized image data by said synthesis means to dodging processing.

A second aspect of the invention is to provide an image processing apparatus, comprising:

selection means for selecting a plurality of optimal images for synthesis among image data of a plurality of images obtained by taking a same scene under different exposure conditions; and

synthesis means for synthesizing the image data of said plurality of the optimal images selected by the selection means to generate synthesized image data of a composite image.

A third aspect of the invention is to provide an image processing apparatus, in the image processing apparatus of the second aspect of the present invention, further comprising;

image processing means for subjecting the synthesized image data synthesized by the synthesis means to dodging processing.

In the image processing apparatus of the above aspects of the invention, it is preferable that synthesis conditions due to the synthesis means are set using at least one of shooting information and the image data of each image to be synthesized; preferably, weighting to each image to be synthesized at the time of synthesizing the images is determined in accordance with the image data; preferably, the plurality of the images of the same scene are taken by a digital camera; and further preferably, the selection means selects the plurality of the optimal images for synthesis using at least one of the image data and shooting time of each image to be synthesized.

### BRIEF DESCRIPTION OF THE DRAWINGS

FIG. 1 is a block diagram of an embodiment of a digital photoprinter utilizing an image processing apparatus of the invention;

FIG. 2 is a block diagram of an embodiment of an image synthesis section of the digital photoprinter shown in FIG. 1;

FIGS. 3A, 3B and 3C are graphs illustrating examples of selections of composite images at the image synthesis section shown in FIG. 2;

FIG. 4 is a graph for calculating a weight coefficient in image processing operations at the image synthesis section shown in FIG. 2;

FIG. 5 is a graph illustrating an example of dodging processing in the image processing operations at the digital photoprinter shown in FIG. 1; and

FIGS. 6A, 6B and 6C are graphs illustrating examples of dodging processing in the image processing operations at the digital photoprinter shown in FIG. 1.

### DETAILED DESCRIPTION OF THE INVENTION

The image processing apparatus of the invention is now described in detail with reference to the preferred embodiments shown in the accompanying drawings.

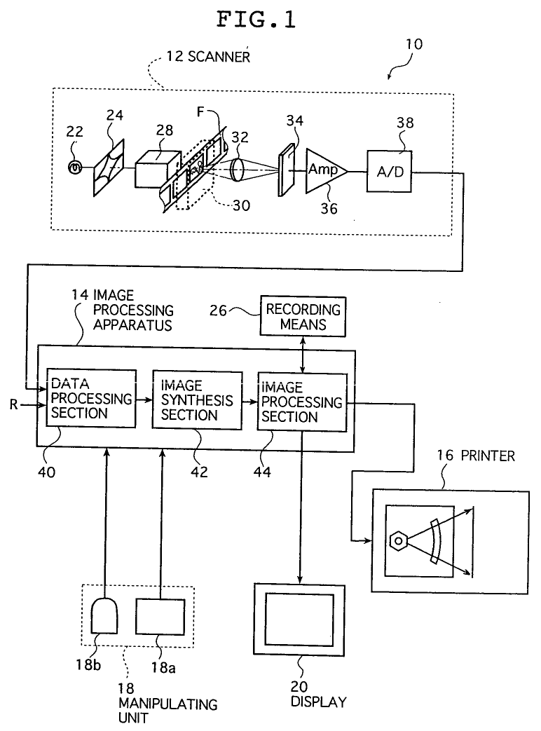

FIG. 1 is a block diagram of an exemplary digital photoprinter using the image processing apparatus of the invention.

The digital photoprinter (which is hereunder referred to simply as “photoprinter”) 10 shown in FIG. 1 comprises essentially a scanner (image reading apparatus) 12 for photoelectrically reading the image photographed and recorded on a film F, an image processing apparatus 14 according to the invention which performs image processing on the thus read image data (image information) and with which the photoprinter 10 as a whole is manipulated and controlled, a printer 16 which performs imagewise exposure of a light-sensitive material (photographic paper) with light beams modulated in accordance with the image data delivered from the image processing apparatus 14 and which performs development and other necessary processing to produce a (finished) print and recording means (recording medium driver) 26 for recording (writing) the image data outputted from the image processing apparatus 14 into a recording media such as a floppy disk and the like as an image file, or for reading the image data recorded in the recording media to provide them to the image processing apparatus 14 and the like.

Connected to the image processing apparatus 14 are a manipulating unit 18 having a keyboard 18a and a mouse 18b for inputting (setting) various conditions, selecting and commanding a specific processing step and entering a command and so forth for effecting color/density correction, as well as a display 20 for representing the image captured with the scanner 12, various manipulative commands and pictures for setting and registering various conditions.

The scanner 12 is an apparatus with which the images recorded on the film F and the like are read photoelectrically frame by frame. It comprises a light source 22, a variable diaphragm 24, a diffuser box 28 which diffuses the reading light incident on the film F so that it becomes uniform across the plane of the film F, an imaging lens unit 32, an image sensor 34 having line CCD sensors capable of reading R (red), 6 (green) and B (blue) images, an amplifier (Amp) 36 and an A/D (analog/digital) converter 38.

In the photoprinter 10, dedicated carriers are available that can be loaded detachably into the body of the scanner 12 in accordance with the type or the size of the film used (e.g. whether it is a film of the Advanced Photo System (APS) or a negative or reversal film of 135 size), the format of the film (e.g. whether it is a strip or a slide) or other factor. By replacing one carrier with another, the photoprinter 10 can be adapted to process various kinds of films in various modes. The images (frames) that are recorded on the film and which are subjected to the necessary procedure for print production are transported to and held in a specified reading position by means of the carriers.

The scanner 12 captures the images recorded on the film F in the following manner; the reading light from the light source 22 has its quantity adjusted by means of the variable diaphragm 24 and is incident on the film F held in the specified reading position by means of the carrier and thereafter passes through the film to produce projected light bearing the image recorded on the film F.

The illustrated scanner 12 is adapted to read the image recorded on the film by means of slit scanning. Being held in registry with the reading position, the film F is transported in the longitudinal (auxiliary scanning) direction by means of the carrier 30 as it is illuminated with the reading light. Consequently, the film F is subjected to two-dimensional slit scan with the reading light passing through the slit extending in the main scanning direction, whereupon the image of each frame recorded on the film F is captured.

The reading light passes through the film F held on the carrier 30 and the resulting image bearing, projected light is focused by the imaging lens unit 32 to form a sharp image on the light-receiving plane of the image sensor 34.

The image sensor 34 is a 3-line color CCD sensor comprising a line CCD sensor for reading an R image, another line CCD sensor for reading a G image, and further another line CCD sensor for reading a B image with respective line CCD sensors extending in the main scanning direction. The projected light from the film F is separated into three primary colors R, G and B and captured photoelectrically by means of the image sensor 34.

The output signals from the image sensor 34 are amplified with Amp 36, converted to digital form in A/D converter 38 and sent to the image processing apparatus 14 of the invention.

It should be noted that the scanner to be used in the photoprinter 10 utilizing the invention is by no means limited to a type that relies upon the slit scan technique described above but that it may be of a type that relies upon areal exposure, or a technique by which the image in one frame is scanned across at a time.

The photoprinter 10 utilizing the invention receives not only the image of the film F read by the scanner 12, image data from an image data supply source R such as a scanner reading a reflection original, an imaging device as exemplified as a digital camera or a digital video camera, computer communication systems such as the Internet, recording media such as a floppy disk, an MO (Magneto-optical) disk (photomagnetic recording media) and the like to produce a print that reproduces these image or image data.

As already mentioned, the digital signals outputted from the scanner 12, the digital camera and the like are fed into the image processing apparatus 14 (which is hereinafter referred to as “processing apparatus 14”) of the invention.

The processing apparatus 14 comprises a data processing section 40, an image synthesis section 42 and an image processing section 44. In addition to these sections, the processing apparatus 14 further includes a CPU for controlling and managing the overall operation of the photoprinter 10 including the processing apparatus 14, memories for storing the information necessary for the operation and the like of the photoprinter 10. The manipulating unit 18 and the display 20 are connected to related sites via the CPU and the like (CPU bus).

The R, G and B digital signals outputted from the scanner 12 are sent to the data processing section 40, where they are subjected to specified data processing steps such as dark correction, defective pixel correction and shading correction. Thereafter, the processed digital signals are transferred into the log conversion, to be converted to digital image data (density data). If the image data is supplied from the image data supply source R, the image data is converted in the data processing section 40 into the image data adaptable to the photoprinter 10 and subjected to necessary processing steps. Thereafter, the image data processed in the data processing section 40 is sent to the image synthesis section 42.

The image synthesis section 42 is a site that selects image data suitable for synthesizing from among image data processed in the data processing section 40 after image data to be synthesized, that is, image data of a plurality of images which are obtained by taking the same scene under different exposure conditions are supplied to the processing apparatus 14 and then synthesizes the thus selected image data. Accordingly, the image data that does not have another image data which has been obtained by taking the same scene under the different exposure conditions is sent to the image processing section 44 without being subjected to any processing in the image synthesis section 42.

According to the invention, the image data processed in the data processing section 40 are not limited to provision to the image synthesis section 42 and when the image synthesis is performed, for example, the only image data that corresponds to an operator's commands may be sent to the image synthesis section 42 with the remaining image data being sent directly to the image processing section 44 without passing through the image synthesis section 42.

In the invention, a plurality of images of the same scene taken under different exposure conditions indicates images of the same scene that are taken with different exposures (quantities of exposure light), that is, for example, images of the same scene that are taken varying an aperture size (F-number) of a stop and/or a shutter speed of the camera in case of the images recorded on the film F and, as another example, images of the same scene that are taken varying a storage time (electronic shutter speed) of the CCD sensor and/or an aperture size of the stop (F-number) in case of the images taken by the digital camera.

Images taken by the digital camera, particularly, sequential images shot sequentially using an AE (auto-exposure) bracketing function of the digital camera (serial-exposure camera) are preferable, since photoelectrical reading by the scanner 12 is not necessary and also an alignment at the image synthesis is easily performed. Moreover, any digital cameras capable of sequential shooting at a high speed are preferable due to their capability in shooting a moving subject.

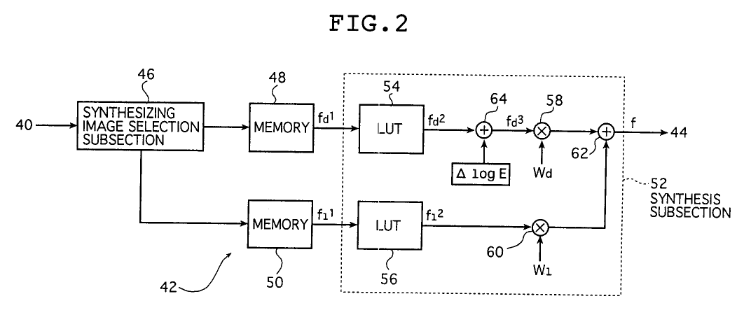

FIG. 2 shows a block diagram of an embodiment of the image synthesis section 42.

The image synthesis section 42 comprises a synthesizing image selection subsection 46, a D (dark) (frame) memory 48, an L (light) (frame) memory 50 and a synthesis subsection 52.

The synthesizing image selection subsection 46 is a site that detects image data of a plurality of images (frames) of the same scene recorded under different exposure conditions from among the supplied image data of the images (frames) using at least one of shooting (photographing) information and image data and thereafter selects the optimal image data of the optimal images (frames) for synthesis. In the illustrated cases, the synthesizing image selection subsection 46 selects image data of two optimal images (frames), that is, two kinds (frames) of optimal image data for synthesis using image data as well as shooting information as a preferred embodiment.

Shooting time is an illustrated example of the shooting information for selecting the image data for synthesis. As an example, the following frame image data of five frame images from im1 to im5 are given as image data:

| | | Shooting Time |
|---|---|---|
| Image Data Name | Dates (y/m/d) | Time (h:m:s) |
| im1 | Apr. 1,1998 | 08:05:35.00 |
| im2 | Apr. 1,1998 | 08:10:00.45 |
| im3 | Apr. 1,1998 | 08:10:00.52 |
| im4 | Apr. 1,1998 | 08:10:01.01 |
| im5 | Apr. 1,1998 | 08:13:00.22 |

The synthesizing image selection section 46 selects a plurality of frame image data having the same scene close to each other in the shooting time. In the above example, three frame image data im2, im3 and im4 are judged as frame image data having the same scene, while frame image data im1 and im5 are judged as image data that do not have another frame image data which has the same scene, or as unnecessary image data for synthesis.

When the judgement is performed as to whether frame image data has the same scene or not on the basis of the shooting time, time difference between frame image data having the same scene and frame image data without having the same scene is not limited in any particular way and, if the time difference is within two seconds, more safely one second, the image data can be judged as frame image data having the same scene.

Moreover, information that frame image data has the same scene may be tagged on the image data of respective frames as shown in the following:

| Image Data Name | |
|---|---|
| im1 | same scene off |
| im2 | same scene on 1 |
| im3 | same scene on 2 |
| im4 | same scene on 3 |
| im5 | same scene off |

A method for acquiring these shooting information is not limited in any particular way and, for example, information of shooting time recorded in the magnetic recording media of film of the APS may be used, while information of image data taken by the digital camera or of image data provided from various recording media may be recorded in a header or a tag of an image file in an earlier time and be read therefrom in a later time. In another case, the operator may input shooting information using the keyboard 18a and the like.

Moreover, the scene information magnetically recorded in the Advanced Photo System will also be available as the information of the same scene so that a function to record the information showing that the image data has the same scene in the image file (recording media) may be provided to imaging devices such as the digital camera and the like.

Then, the synthesizing image selection subsection 46 selects two optimal images (frames) for synthesis from among the image data judged as the same scene.

The image data im1 and im5 that were judged as being unnecessary for synthesis are outputted without synthesizing from the synthesizing image selection subsection 46 to the image processing section 44.

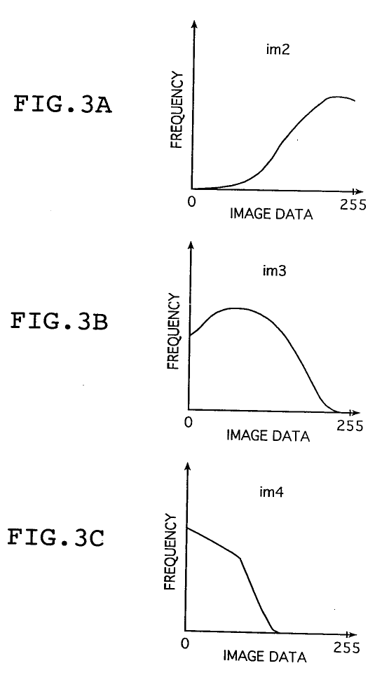

A method for performing the selection of two optimal images is not limited in any particular way and may be, for example, as shown in FIGS. 3A to 3C, a method that selects density histograms of three kinds (frames) of image data im2, im3 and im4 that are judged as having the same scene and thereafter selects as the optimal image data for synthesis two kinds of image data capable of reproducing overall image scene from highlights to shadows without washed-out highlights (minimum density) or dull shadows (maximum density) and having dynamic ranges as wide as possible out of the three kinds of image data. The illustrated two kinds of image data are taken by the digital camera and the smaller one becomes the higher density.

Accordingly, in the illustrated example, image data im2 and im3 are selected. The frame number of image data to be synthesized is not limited to two, and three or more frames of image data may be utilized for synthesis.

Since image data that is not used for synthesis is not required, such image data may be cancelled at the time that the image data suitable for synthesis are selected.

If the image data to be used for synthesis are preliminarily selected and provided, processing in the synthesizing image selection subsection 46 is unnecessary. Moreover, if the processing apparatus is arranged such that the image data to be used for synthesis are always preliminarily selected and provided, the synthesizing image selection subsection 46 is unnecessary.

If two image data having the same scene under different exposure conditions, the image data with a higher density (in the illustration, im2=f_{d}¹ with a lower quantity of exposure light) is outputted to a D (dark) memory 48 and stored therein while the image data with a lower density (in the illustration, im3=fₗ¹ with a higher quantity of exposure light) is outputted to an L (light) memory 50 and stored therein.

The image data f_{d}¹ and fₗ¹ stored in the D memory 48 and the L memory 50, respectively are read out so as to be synthesized into one image data (one image) f.

The synthesis subsection 52 comprises a D(dark)-look-up table (LUT) 54, an L(light)-look-up table (LUT) 56, a multipliers 58, 60 and adders 62 and 64.

The D-LUT 54 and the L-LUT 56 are LUTs for converting image data into subject luminance data f_{d}^{2 and f}ₗ² shown in logarithmic scales, respectively.

The subject luminance data f_{d}² obtained in the D-LUT 54 is then added with ΔLog E in the adder 64 to acquire the subject luminance data f_{d}³. The subject luminance data f_{d}² and fₗ² are data shifted with a specified amount, respectively where ΔLog E is the shifting amount.

Two calculation methods of ΔLog E exist: using shooting information and using image data.

The calculation method using the shooting information is exemplified as a method that uses a following formula applying a shutter speed t_{d} and an aperture size S_{d} of a stop adopted when the image data f_{d}¹ with a higher density is taken, and also a shutter speed tₗ and an aperture size Sₗ of a stop adopted when the image data fₗ with a lower density is taken:

ΔLog E=(Logtₗ−LogSₗ²)−(Logt_{d}−LogS_{d}²)

On the other hand, the calculation method using the image data is exemplified as a method that first selects pixels without washed-out highlights and dull shadows from each of the higher density image data and the lower density image data to make the thus selected pixels as sets R and then calculates respective averages of the sets R and finally defines the difference between the two averages of the sets R as ΔLog E. Namely, ΔLog E is calculated by the following formula:

ΔLog E=(average of fₗ² of set R)−(average of f_{d}²of set R)

The method to use the image data can cancel an error timely so that the method is preferable with reference to accuracy whereas the method to use shooting information is advantageous because of its easier calculation. These shooting information can be obtained by following a method in view of the shooting time as described above.

In the illustration, the synthesis is performed after the image data is converted into the subject luminance. However, if it is intended that two images are smoothly joined, the LUT for converting the image data into the subject luminance may be eliminated.

Moreover, as a method for correcting the difference of these exposure conditions, a method that sets one of the higher density image data and the lower density image data as a standard and then make the other one to accord with the standard can be available. In this case, it is possible that correction of exposure conditions by one of D-LUT 54 and L-LUT 56 that corresponds to the image data set as the standard becomes unnecessary.

Generally, image signals taken and recorded on the recording media by the digital camera and the like are subjected to γ (gradation) conversion in many cases such that the image is properly seen on a CRT monitor and the like. Accordingly, it is preferable that the characteristics of the γ conversion of the camera is detected and a reverse conversion of the γ conversion is performed by the conversion LUT adapted to the subject luminance. It may be that, for example, γ characteristics corresponding to each kind of cameras are previously stored and then, the kind of camera, as well as the above mentioned shooting information are acquired and the γ characteristics corresponding to these information are read so that their reverse characteristics may be set in the LUT.

In the illustration, the shift of ΔLog E is performed by the adder 64. However, the adder 64 can be deleted by incorporating the function of the adder 64 into the LUT for converting the image data f_{d}¹ and the like to the subject luminance.

The subject luminance data f_{d}³ processed in the adder 64 and the image data fₗ² processed in the LUT 56 are processed in the multipliers 58 and 60, respectively and the respective resulted image data are added in the adder 62 to be a single image data f.

The multipliers 58 and 60 can prevent formation of a false contour and the like at a joint of two image data by multiplying the image data f_{d}³ and fₗ² by weighting coefficients Wd and Wl, respectively.

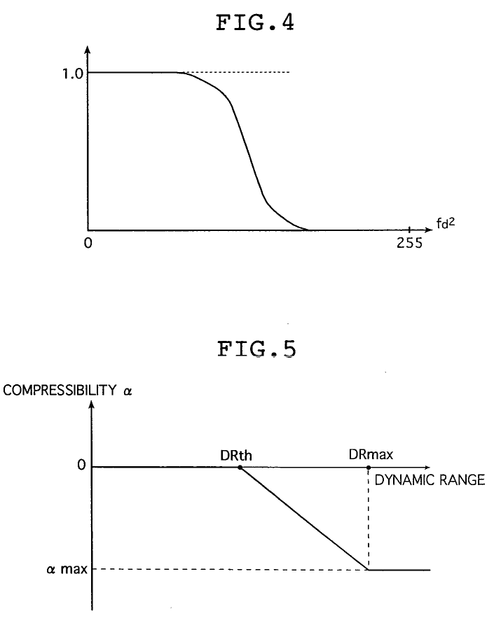

The weighting coefficients are calculated, for example, using a table illustrated in FIG. 4 from the formula: Wd+Wl=0. In this case, synthesis of two image data has been performed not only by using the image data f_{d}³ in a high density region without having dull shadows and the image data fₗ² in a low density region without having washed-out highlights, but also by applying weights corresponding to respective image data at the joint of two image data.

The image data outputted from the image synthesis section 42 is sent to the image processing section 44.

The image processing section 44 is a site where the digital image data processed in the data processing section 40 is subjected to a specified processing and the thus processed image data are further converted with a 3D (three-dimensional)-LUT or the like into the image data that corresponds to image recording with the printer 16 or to the representation on the display 22.

The image processing that is performed in the image processing section 44 is not limited in any particular way and various known processing steps are illustrated such as gray balance adjustment, gradation correction and density adjustment using an LUT, shooting light source kind correction and saturation adjustment using matrix (MTX) operations, electronic magnification, dodging and sharpening (sharpness correction) using averaging and interpolation and the like employing any one of a low-pass filter, an adder, an LUT, an MTX, etc. and any combination thereof.

Various kinds of processing conditions in the image processing section 44 may be set by the image data acquired by a prescan that is performed by reading the image roughly prior to a main scan that acquires an output image data or the image data that is thinned out by the image data corresponding to the output image data to the printer 16.

In the processing apparatus 14 according to the invention, the image data synthesized from two kinds of image data having the same scene under different exposure conditions is preferably subjected to dodging processing. This dodging processing is mentioned as dynamic range compression processing of the image data where the image to be processed is made unsharp to form an unsharp image data, and then a highlight region and a shadow region of the image are independently compressed while maintaining gradation with an intermediate density region by processing the image data before being made unsharp using the formed unsharp image data.

The image data obtained by synthesizing the image data with different exposure conditions has a wide dynamic range in a great degree that, in some cases, exceeds the dynamic range reproducible by the printer 16 and the like which can change the image data into a visible image. Accordingly, it is necessary that, in order to obtain an appropriate visible image, the dynamic range of the image data is compressed into a range where the image can be reproduced by the printer and the like. Compression processing of the dynamic range of the image data is performed in the aforementioned publications JPAs No. 7-131704 and No. 7-131718. However, it is difficult to obtain the image data that brings about high-quality images as prints or photographs to be produced by the photoprinter 10 using the compression processing disclosed in the above publications.

On the other hand, the above mentioned dodging processing is capable of obtaining the same effect even with a higher degree of freedom and image correction ability as conventional dodging by a direct exposure and also can constantly form prints reproducing high-quality images from the image data synthesized of image data of the same scene under different exposure conditions.

As an example of dodging processing methods, the following method is illustrated.

First, image data (hereinafter called as “original image data”) after being subjected to specified image processing such as gray balance adjustment, gradation correction, density adjustment, saturation adjustment and the like is sent to an adder and an MTX calculator in parallel.

The MTX calculator forms a luminance image data of the original image from the original image data corresponding to respective R, G and B using a YIQ base. For example, Y component of the YIQ base is calculated from the image data of R, G and B using the following formula:

Y=0.3R+0.59G+0.11B

Next, the luminance image data obtained by the MTX calculator is processed by an LPF (low pass filter) to take out a low frequency component allowing the luminance image to be made unsharp two-dimensionally so that an unsharp image data of the read image is obtained.

As this LPF, the LPF of Finite Impulse Response (FIR) type that has been conventionally employed for forming an unsharp image data may be used. However, the LPF of Infinite Impulse Response (IIR) type is preferably used from the standpoint of the fact that the LPF of IIR type may form the unsharp image that can be greatly unsharpened with a small-sized circuit. Moreover, a median filter (MF) may be used instead of the LPF. The MF is preferable from the point that the unsharp image data which cuts a noise (high frequency component) in a flat area while maintaining an edge can be obtained. Furthermore, making use of the above advantage of the MF and also of formability of the greatly unsharpened image data of the LPF, it is preferable that the MF and the LPF are used concurrently to produce an image which is then weighted.

The obtained unsharp image data is further processed by a dynamic range compression table (hereinafter called as “compression table”).

In this dodging processing, by adding the original image data with the unsharp image data processed by this compression table at the aforementioned adder, the original image data is subjected to the dodging processing by means of compressing the dynamic range of the image data in a nonlinear way so as to acquire an output image data where the dynamic range, gradation and density of luminance area are appropriate, and prints reproducible high-quality images giving the same impression as a person obtains from the original scene. In other words, the compression table is mentioned as a table for subjecting the unsharp image data to necessary processing steps to obtain an image data for a processing purpose that suitably compresses dynamic range of the original image data and the like.

An exemplary formation of this compression table is described below.

First, an overall (dynamic range) compressibility a is calculated and a compression function f(α) is then set using this compressibility α.

A function as shown in, for example, FIG. 5 is set in the image processing section 44 and the compressibility α is calculated from the dynamic range (DR) of the image data using this function. This function is set such that when the dynamic range is smaller than a threshold DRth, the compressibility α becomes 0 and the dynamic range is not compressed in an image having a small dynamic range. In other words, this reason is that when the image having the small dynamic range is compressed, the contrast of the image is lowered and an image quality is deteriorated on the contrary.

A better image can be obtained by processing an image having a spot-like brightest portion resulting from an electric lamp or the like existing in the image so as to make the spot-like brightest portion to the lowest density in a finished print rather than to form gradation (by increasing in gradation hardness) by a dynamic range compressing process. Thus, even if the dynamic range becomes greater than the threshold DRmax in the function shown in FIG. 5, the compressibility a is not any more decreased below the lowest value a max in the dynamic range beyond the threshold.

The overall compression function f(α) is formed using this compressibility α.

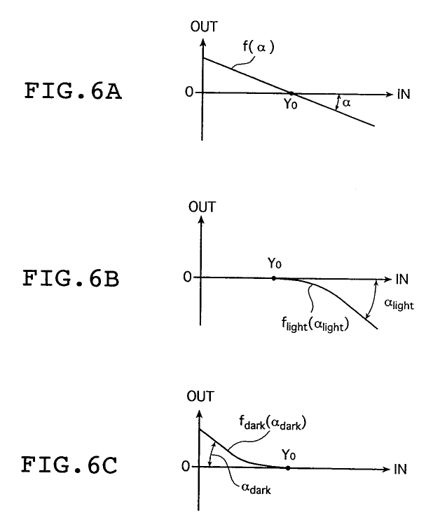

As shown in FIG. 6A, this compression function f(α) is a monotonously decreasing function that uses a certain signal value as a reference value Y₀, that is, a point of intersection with the abscissa (output 0) and has an inclination of the compressibility α. This reference value Y₀ is a reference density which may be suitably set in accordance with a density of a main subject or the like that serves as the center of the image. When, for example, a person is the main subject, the reference value Y₀ is a print density which is approximately the same as a density of a skin color. In this case, the reference value Y₀ is set between 0.5 and 0.7 and preferably at about 0.6.

Next, (dynamic range) compressibility alight of the bright portion and (dynamic range) compressibility α_{dark} of the f_{dark} portion are set, thereby forming compression function f_{light} (α_{light}) of the bright portion and compression function dark (α_{dark}) of the dark portion.

As shown in FIG. 6B, the compression function f_{light} (α_{light}) of the bright portion is a decreasing function having an output that is located below the abscissa (output: 0, minus side) on the bright portion side from the reference value Y₀ and the inclination of a straight portion is set to compressibility α_{light} of the bright portion. Note, the output on the dark portion side from the reference value Y₀ is 0. This compressibility alight is set such that the image data of the bright portion that has been obtained by dodging processing performed in accordance with image characteristic amounts of density histogram, highlights and the like becomes the image data of a print in an image reproducible gamut.

On the other hand, as shown in FIG. 6C, the compression function f_{dark} (α_{dark}) of the dark portion is a decreasing function having an output that is located above the abscissa on the dark portion side from the reference value Y₀ and the inclination of a straight portion is set to the dark portion compressibility α_{dark}. Note, the output on the bright portion side from the reference value Y₀ is 0. This compressibility α_{dark} is set as in the case of α_{light} such that the image data of the dark portion becomes the image data of a print in an image reproducible gamut in accordance with image characteristic amounts of density histogram, shadows and the like.

After the overall compression function f(α), the compression function f_{light} (α_{light}) of the bright portion and the compression function f_{dark} (α_{dark}) of the dark portion are calculated in a manner as described above, the compression function fₜₒₜₐₗ (α) is set by adding them using the following formula so as to form the compression table using the thus obtained compression function fₜₒₜₐₗ (α):

fₜₒₜₐₗ(α)=f_{light}(α)+f_{light}(α_{light})+f_{dark} (α_{dark})

When the reference value Y₀ is fixed and the bright portion compressibility and the dark portion compressibility are independently set in accordance with the above compression table forming method, the dynamic range can be compressed by adjusting only the bright portion and the dark portion without changing the gradation of the intermediate image density portion.

The unsharp image data formed in the above LPF is processed by this compression table and then sent to an adder. As described above, the original image data has been sent to the adder, where the thus sent original image and the unsharp image data (luminance image data) processed in the compression table are added. By this processing step, dodging processing that is to compress the dynamic range of the original image data is performed.

More particularly, as is apparent from FIGS. 6A, 6B, and 6C the unsharp image data processed in the compression table is the image data having the bright portion set to be minus and the dark portion set to be plus. Accordingly, addition of this unsharp image data to the original image data permits the bright portion of the image data to be reduced and the dark portion thereof to be raised. Namely, the dynamic range of the image data is compressed.

A passband of the LPF used for forming the unsharp image data corresponds to a large area contrast and a local contrast is a higher frequency component than the passband of the LPF so that the component is not compressed by the unsharp image data passing through the LPF. Therefore, the image obtained by the addition processing at the adder comes to be a high-quality image in which the dynamic range is compressed while maintaining the local contrast.

As described above, the image (image data) processed in the image processing section 44 is outputted to the display 20, the printer 16 and the like to be a visible image, or outputted to the recording means 26 to be recorded in the recording media as an image file.

The printer 16 comprises a printer (exposing device) that records a latent image on a light-sensitive material (photographic paper) by exposing it in accordance with the supplied image data and a processor (developing device) that performs specified processing steps on the exposed light-sensitive material and which outputs it as a print. To give one example of the printer's operation, the light-sensitive material is cut to a specified length in accordance with the size of the final print; thereafter, the printer records a back print and three light beams for exposure to red (R), green (G) and blue (B) in accordance with the spectral sensitivity characteristics of the light-sensitive material are modulated in accordance with the image data outputted from the processing apparatus 14; the three modulated light beams are deflected in the main scanning direction while, at the same time, the light-sensitive material is transported in the auxiliary scanning direction perpendicular to the main scanning direction so as to record a latent image by two-dimensional scan exposure with said light beams. The latent image bearing light-sensitive material is then supplied to the processor. Receiving the light-sensitive material, the processor performs a wet development process comprising color development, bleach-fixing and rinsing; the thus processed light-sensitive material is dried to produce a finished print; a plurality of prints thus produced are sorted and stacked in specified units, say, one roll of film.

The recording means 26 records the image data processed with the processing apparatus 14 in the recording media such as CD-R and the like as an image file, or reads the image file from the recording media.

The recording media that reads the image data (image file) outputted from the processing apparatus 14 of the invention is not limited in any particular way and magnetic recording media such as a floppy disk, a removable hard disk (Zip, Jaz and the like), DAT (digital-audio tape) and the like, photomagnetic recording media such as an MO (photomagnetic) disk, an MD (mini-disk), a DVD (digital video disk) and the like, optical recording media such as a CD-R and the like, a card memory and the like such as a PC card, smart media and the like are illustrated.

While the image processing method of the present invention has been described above in detail, it should be noted that the invention is by no means limited to the foregoing embodiments and various improvements and modifications may of course be made without departing from the scope and spirit of the invention.

As described above in detail, the present invention can secure a sufficient dynamic range of image data even when a scene with a high contrast is taken by a digital camera or the like that has a narrow photographing latitude and can select the optimal image for synthesis from among a plurality of images of the same scene under different exposure conditions. As a result, the digital photoprinter of the invention can produce prints that reproduce high-quality images.

What is claimed is:

1. An image processing apparatus, comprising:
synthesis means for synthesizing image data of a plurality of images obtained by taking a same scene under different exposure conditions to generate synthesized image data of a composite image; and
image processing means for subjecting the synthesized image data by said synthesis means to dodging processing.

2. The image processing apparatus according to claim 1, wherein synthesis conditions due to said synthesis means are set using at least one of shooting information and the image data of each image to be synthesized.

3. The image processing apparatus according to claim 1, wherein weighting to each image to be synthesized at the time of synthesizing the images is determined in accordance with the image data.

4. The image processing apparatus according to claim 1, wherein said plurality of the images of the same scene are taken by a digital camera.

5. An image processing apparatus, comprising:
selection means for selecting a plurality of optimal images for synthesis among image data of a plurality of images obtained by taking a same scene under different exposure conditions; and
synthesis means far synthesizing the image data of said plurality of the optimal images selected by said selection means to generate synthesized image data of a composite image.

6. An image processing apparatus according to claim 5, further comprising image processing means for subjecting the synthesized image data by said synthesis means to dodging processing.

7. The image processing apparatus according to claim 5, wherein synthesis conditions due to said synthesis means are set using at least one of shooting information and the image data of each image to be synthesized.

8. The image processing apparatus according to claim 5, wherein weighting to each image to be synthesized at the time of synthesizing the images is determined in accordance with the image data.

9. The image processing apparatus according to claim 5, wherein said plurality of the images of the same scene are taken by a digital camera.

10. The image processing apparatus according to claim 5, wherein said selection means selects said plurality of the optimal images for synthesis using at least one of the image data and a shooting time of each image to be synthesized.

11. The image processing apparatus according to claim 10, wherein said shooting shooting time between images is within two seconds.

12. The image processing apparatus according to claim 1, wherein said dodging processing is dynamic range compression processing of said image data wherein an image to be processed is made unsharp thereby forming unsharp image data.

13. The image processing apparatus according to claim 12, wherein a highlight region and a shadow region of said image are independently compressed while maintaining gradation with an intermediate density region.

14. The image processing apparatus according to claim 13, wherein said compression comprises processing said image data before being made unsharp using said unsharp image data.

15. The image processing apparatus according to claim 12, wherein said image is made unsharp by filtering the low frequency components of said image.

16. The image processing apparatus according to claim 5, wherein when images to be synthesized are provided by a user, said image data will not go through said selection means.

17. The image processing apparatus according to claim 10, wherein information regarding shooting time of said image data taken by a digital camera or of image data provided from various recording media is recorded in a header or a tag of an image file in an earlier time and read therefrom in a later time.

18. The image processing apparatus according to claim 10, wherein image data not used for synthesis may be cancelled at the time that image data suitable for synthesis are selected.

19. The image processing apparatus according to claim 1, wherein said synthesis means comprises a dark look up table opposite a light look up table, wherein multipliers and adders are connected to said dark look up table and said light look up table.

20. An image processing apparatus, comprising:
selection means for judging a plurality of images obtained by taking a same scene under different exposure conditions among a plurality of supplied images, and for selecting a plurality of optimal images for synthesis among image data of said plurality of images judged as the same scene; and
synthesis means for synthesizing the image data of said plurality of the optimal images selected by said selection means to generate synthesized image data of a composite image.

21. An image processing apparatus, comprising;
acquiring means for acquiring image data of a plurality of first images to be synthesized that are obtained by taking a single scene under different exposure conditions;
synthesis means for synthesizing said image data of said plurality of first images obtained by said acquiring means to generate synthesized image data of a composite image; and
image processing means for subjecting the synthesized image data of said composite image by said synthesis means to dodging processing,
wherein said synthesis means sets synthesis conditions of image synthesis using said image data of said plurality of first images, and synthesizes said image data of said plurality of first images using said set synthesis conditions.

22. The image processing apparatus according to claim 21, wherein said synthesis means performs said image synthesis after converting said image data of said plurality of first images to subject luminance data of logarithmic scales.

23. The image processing apparatus according to claim 22, wherein said synthesis conditions are shifting amounts of the subject luminance data of respective images from the subject luminance data of one image among said plurality of first images, and
wherein said synthesis means selects pixels without washed-out highlights and dull shadows from the subject luminance data of said one image and said respective images, respectively, determines respective averages of the subject luminance data of sets of the selected pixels, and calculates each difference between each of the determined averages of said respective images and the determined average of said one image as each of the shifting amounts of the respective images.

24. The image processing apparatus according to claim 21, wherein weighting to each image to be synthesized at the time of the image synthesis is determined in accordance with the image data-of said plurality of first images.

25. The image processing apparatus according to claim 21, wherein said plurality of first images are taken by a digital camera, and said synthesized image data output from said synthesis means or said image processing means includes image data for outputting as a photographic print.

26. The image processing apparatus according to claim 21, wherein said synthesis means comprises:
a memory for storing the image data of said plurality of first images;
converting means for converting said image data of said plurality of first images read out from said memory to subject luminance data of logarithmic scales;
setting means for setting said synthesis conditions as shifting amounts of the subject luminance data of respective images from the subject luminance data of one image among said plurality of first images;
a first adder for adding the set shifting amounts to the subject luminance data of said respective images, respectively;
a multiplier for performing weighting to the subject luminance data of said one image and the added subject luminance data of said respective images, respectively; and
a second adder for adding the weighted subject luminance data of said one image and the weighted added subject luminance data of said respective images.

27. An image processing apparatus, comprising:
acquiring means for acquiring image data of a plurality of second images obtained by taking a single scene under different exposure conditions;
selection means for selecting a plurality of optimal first images for synthesis among said image data of said plurality of second images obtained by said acquiring means; and
synthesis means for synthesizing image data of said plurality of the optimal first images selected by said selection means to generate synthesized image data of a composite image,
wherein said synthesis means sets synthesis conditions of image synthesis using said image data of said plurality of first images, and synthesizes said image data of said plurality of first images using said set synthesis conditions.

28. The image processing apparatus according to claim 27, further comprising image processing means for subjecting the synthesized image data of the composite image by said synthesis means to dodging processing.

29. The image processing apparatus according to claim 27, wherein said synthesis means comprises:
a memory for storing the image data of said plurality of first images;
converting means for converting said image data of said plurality of first images read out from said memory to subject luminance data of logarithmic scales;
setting means for setting said synthesis conditions as shifting amounts of the subject luminance data of respective images from the subject luminance data of one image among said plurality of first images;
a first adder for adding the set shifting amounts to the subject luminance data of said respective images, respectively;
a multiplier for performing weighting to the subject luminance data of said one image and the added subject luminance data of said respective images, respectively; and
a second adder for adding the weighted subject luminance data of said one image and the weighted added subject luminance data of said respective images.

30. The image processing apparatus according to claim 27, wherein weighting to each image to be synthesized at the time of the image synthesis is determined in accordance with the image data of said plurality of first images.

31. The image processing apparatus according to claim 27, wherein said plurality of first images are taken by a digital camera, and said synthesized image data output from said synthesis means or said image processing means includes image data for outputting as a photographic print.

32. The image processing apparatus according to claim 27, wherein said selection means selects said plurality of optimal first images for synthesis using at least one of shooting time of day and said image data of said plurality of second images.

33. The image processing apparatus according to claim 32, wherein said selection means selects said plurality of optimal first images using said shooting time of day and said image data of said plurality of second images.

34. The image processing apparatus according to claim 33, wherein said selection means judges a plurality of third images obtained by taking a single scene under different exposure conditions using said shooting time of day of said plurality of second images, prepares respective histograms of said plurality of third images using image data of said plurality of third images, and selects said plurality of optimal first images for synthesis using the prepared respective histograms.

35. An image processing apparatus, comprising:
acquiring means for acquiring image data of a plurality of first images to be synthesized that are obtained by taking a single scene under different exposure conditions;
synthesis means for synthesizing said image data of said plurality of first images obtained by said acquiring means to generate synthesized image data of a composite image; and
image processing means for subjecting the synthesized image data of said composite image by said synthesis means to dodging processing,
wherein said synthesis means sets synthesis conditions of image synthesis using shutter speeds and aperture sizes of a stop of a camera at the time of taking said plurality of first images among shooting information of said plurality of first images, and synthesizes said image data of said plurality of first images using said set synthesis conditions, and
wherein said synthesis means
performs said image synthesis after converting said image data of said plurality of first images to subject luminance data of logarithmic scales,
sets said synthesis conditions as shifting amounts of the subject luminance data of respective images from the subject luminance data of one image among said plurality of first images, as well as,
determines logarithmic values of the shutter speeds and the aperture sizes of the stop when said one image and said respective images were taken respectively, calculates each first difference between each of the determined logarithmic values of the shutter speeds when said respective images were taken and each of the determined logarithmic values of the shutter speeds when said one image was taken, and each second difference between each of the determined logarithmic values of the aperture sizes of the stop when said respective images were taken and each of the determined logarithmic values of the aperture sizes of the stop when said one image was taken, and adds said each first difference and said each second difference for said respective images to calculate the shifting amounts of the respective images.

36. The image processing apparatus according to claim 35, wherein weighting to each image to be synthesized at the time of the image synthesis is determined in accordance with the image data of said plurality of first images.

37. The image processing apparatus according to claim 35, wherein said plurality of first images are taken by a digital camera, and said synthesized image data output from said synthesis means or said image processing means includes image data for outputting as a photographic print.

38. The image processing apparatus according to claim 35, wherein said synthesis means comprises:
a memory for storing the image data of said plurality of first images;
converting means for converting said image data of said plurality of first images read out from said memory to subject luminance data of logarithmic scales;
setting means for setting said synthesis conditions as shifting amounts of the subject luminance data of respective images from the subject luminance data of one image among said plurality of first images;
a first adder for adding the set shifting amounts to
the subject luminance data of said respective images, respectively;
a multiplier for performing weighting to the subject luminance data of said one image and the added subject luminance data of said respective images, respectively; and
a second adder for adding the weighted subject luminance data of said one image and the weighted added subject luminance data of said respective images.

39. An image processing apparatus, comprising:
acquiring means for acquiring image data of a plurality of second images obtained by taking a single scene under different exposure conditions;
selection means for selecting a plurality of optimal first images for synthesis among said plurality of second images obtained by said acquiring means; and
synthesis means for synthesizing image data of said plurality of the optimal first images selected by said selection means to generate synthesized image data of a composite image,
wherein said synthesis means sets synthesis conditions of image synthesis using shutter speeds and aperture sizes of a stop of a camera at the time of taking said plurality of first images among shooting information of said plurality of first images, and synthesizes said image data of said plurality of first images using said set synthesis conditions, and
wherein said synthesis means
performs said image synthesis after converting said image data of said plurality of first images to subject luminance data of logarithmic scales,
sets said synthesis conditions as shifting amounts of the subject luminance data of respective images from the subject luminance data of one image among said plurality of first images, as well as,
determines logarithmic values of the shutter speeds and the aperture sizes of the stop when said one image and said respective images were taken respectively, calculates each first difference between each of the determined logarithmic values of the shutter speeds when said respective images were taken and each of the determined logarithmic values of the shutter speeds when said one image was taken, and each second difference between each of the determined logarithmic values of the aperture sizes of the stop when said respective images were taken and each of the determined logarithmic values of the aperture sizes of the stop when said one image was taken, and adds said each first difference and said each second difference for said respective images to calculate the shifting amounts of the respective images.

40. The image processing apparatus according to claim 39, further comprising image processing means for subjecting the synthesized image data of the composite image by said synthesis means to dodging processing.

41. The image processing apparatus according to claim 39, wherein weighting to each image to be synthesized at the time of the image synthesis is determined in accordance with the image data of said plurality of first images.

42. The image processing apparatus according to claim 39, wherein said plurality of first images are taken by a digital camera, and said synthesized image data output from said synthesis means or said image processing means includes image data for outputting as a photographic print.

43. The image processing apparatus according to claim 39, wherein said selection means selects said plurality of optimal first images for synthesis using at least one of shooting time of day and said image data of said plurality of second images.

44. The image processing apparatus according to claim 43, wherein said selection means selects said plurality of optimal first images using said shooting time of day and said image data of said plurality of second images.

45. The image processing apparatus according to claim 44, wherein said selection means judges a plurality of third images obtained by taking a single scene under different exposure conditions using said shooting time of day of said plurality of second images, prepares respective histograms of said plurality of third images using image data of said plurality of third images, and selects said plurality of optimal first images for synthesis using the prepared respective histograms.

46. The image processing apparatus according to claim 39, wherein said synthesis means comprises:
a memory for storing the image data of said plurality of first images;
converting means for converting said image data of said plurality of first images read out from said memory to subject luminance data of logarithmic scales;
setting means for setting said synthesis conditions as shifting amounts of the subject luminance data of respective images from the subject luminance data of one image among said plurality of first images;
a first adder for adding the set shifting amounts to the subject luminance data of said respective images, respectively;
a multiplier for performing weighting to the subject luminance data of said one image and the added subject luminance data of said respective images, respectively; and
a second adder for adding the weighted subject luminance data of said one image and the weighted added subject luminance data of said respective images.
